(19) United States
(12) Patent Application Publication
(10) Pub. No.: US 2009/0078278 A1
(43) Pub. Date: Mar. 26, 2009

(54) MULTI-FUNCTION NIPPER DEVICE

(76) Inventor: Christine TRAN, San Diego, CA (US)

Correspondence Address: FRANK G MORKUNAS, 7750 DAGGET ST, SUITE 203, SAN DIEGO, CA, 92111, US

(21) Appl. No.: 11/861,572

(22) Filed: Sep. 26, 2007

(51) Int. Cl. A45D 29/18; A45D 29/02; A45D 29/16; B26B 13/22; A45D 29/17

(52) U.S. Cl. 132/75.5; 30/28

(57) ABSTRACT

An manicuring nipper having a cutting head with first blade and a second blade, a first handle affixed to the first blade and a second handle affixed to the second blade, each handle being pivotably attached to the other at a pivot connection, and a cuticle pusher at a distal end of either handle and a nail cleaner at a distal end of the other handle wherein the cuticle pusher or the nail cleaner or both are removably attachable to their respective handle.

### CROSS REFERENCES TO RELATED APPLICATIONS

None.

### STATEMENT REGARDING FEDERALLY-SPONSORED RESEARCH OR DEVELOPMENT

None.

### BACKGROUND

This improved manicuring device as set forth in this disclosure relates to an improvement in manicuring devices, and more particularly to an improved nipper which functions not only as a trimmer, but as a cuticle pusher, a nail cleaner, and an applicator for applying various patterns on fingernails such as, but not limited to, flower patterns, dots, hearts, raindrops, and the like.

The fingernail is an important skin appendage. It covers the dorsal surface of the terminal phalanges; i.e., the most distal bones of each finger and toe. Fingernails serve to protect the tips of the fingers and to assist in picking up small objects. They may be decorated or plain.

Fingernails are composed of laminated layers of a protein called keratin, which is also found in one's hair and skin. As a result, fingernails should be kept in good condition and clipped regularly in a rounded or squared shape.

Most of the fingernail is pink because of the underlying vascular tissue. The crescent-shaped half-moon-like white area at the bottom of the fingernail is the lunula. The lunula has a white-ish appearance because the vascular tissue under it does not show through. The lunula is the area in which new nail growth occurs.

The cuticle is just below the lunula and the nail body is above the lunula and is basically pinkish in color. The cuticle is the tissue that overlaps the lunula at the base of the fingernail. It serves as a barrier to keep bacteria from entering one's body and protects the new keratin cells that slowly emerge as the fingernail grows. Consequently, it is best to keep the cuticle where it is; but it also should be regularly groomed.

As the fingernail grows, it will extend beyond the fingertip. The part of the fingernail which extends beyond the fingertip is referred to as the free edge and it also is white-ish in color, or pinkish but not as pink as the nail body.

Basic care of the fingernail generally requires trimming of the free edge, cleaning under the free edge, and trimming of the cuticle. Before the cuticles may be properly trimmed, they first may generally be softened with a specialized cuticle cream, and then they should be slightly pushed back such that old or dead cuticle tissue will gather and then be more easy to cut. After this preliminary preparation, the cuticle is then trimmed carefully with a cuticle nipper.

Nail care devices for the proper trimming/grooming of the fingernail and cuticle generally include a [1] cuticle nipper; [2] a cuticle pusher; and [3] a nail cleaner for cleaning from under the free edge. In essence three separate devices which requires placing one device down to use another. Given the nature of the procedure, a user may have to alternate between pusher and trimmer several times and between cleaner and trimmer several times to ensure proper grooming has been realized.

A cuticle nipper is a scissor-like device with two opposing knife-like blades which, when pressed together, serve to cut and trim the cuticles and dead skin around the nails.

A cuticle pusher should first be used on the cuticle to push back and gather the distal cuticle. Pushers generally tend to be made of wood, plastic, or metal. They may also be used to push, but not cut, the cuticle back for a more even appearance. By pushing the skin back, one also reveals more of the half-moon shape of the lunula.

The nail cleaner is a device having a handle at one end and the cleaner portion at the other end. The cleaner portion can be flat and slightly pointed, may be flat and straight as a screwdriver head, may be flat and curved at the end, or may be pointed and have a rounded ball-like head or a rounded flat head, each of varying sizes, at the end of the distal point.

In any event, the cleaner portion is placed into the underside of the free edge, adjacent to the fingertip, pressed on the underside of the free edge, and translated from one side to the other to scrape and remove dirt and debris from the underside. The process may be repeated as necessary until the underside of the free edge is clean and white-like. The cleaner having the rounded end also may be used to create various patterns and designs on the fingernail [such as, but not limited to, flower patterns, dots, hearts, raindrops, and the like], as desired, when first dipped in a suitable polish, a water-based paint, or other solution before dabbing onto the polished nails.

The device of this present disclosure combines the elements of all these stand-alone prior art devices into a single device to thereby permit the user to be more effective and more efficient in the nail and cuticle trimming and grooming process. The single device eliminates the need to switch back and forth between the multiple devices. All the user needs to do with the device of this present disclosure is to rotate [or flip] it from one desired element to the next desired element.

All these elements in a single device also eliminates the frustration associated with the very possibility of misplacing one prior art device and then searching for it or a suitable replacement while in the middle of a trimming and grooming session. Additionally, with all these eliminates incorporated into a single device renders the cost of manufacture and cost to purchase substantially less than the cost of buying several stand-alone prior art devices.

The foregoing has outlined some of the more pertinent objects of the improved manicuring device as set forth in this disclosure. These objects should be construed to be merely illustrative of some of the more prominent features and applications of the improved manicuring device. Many other beneficial results can be attained by applying the disclosed improved manicuring device in a different manner or by modifying the improved manicuring device within the scope of the disclosure. Accordingly, other objects and a fuller understanding of the improved manicuring device as set forth in this disclosure may be had by referring to the summary of the improved manicuring device and the detailed description of the preferred embodiment in addition to the scope of the improved manicuring device defined by the claims taken in conjunction with the accompanying drawings.

### SUMMARY

The above-noted problems, among others, are overcome by the improved manicuring device as set forth in this disclosure. Briefly stated, the improved manicuring device contemplates a manicuring nipper having a cutting head with first blade and a second blade and a first handle affixed to the first blade and a second handle affixed to the second blade, each of which are pivotably attached to each other at a pivot connection for opening and closing the cutting head for cutting, and a cuticle pusher at a distal end of either handle and a nail cleaner at a distal end of the other handle.

Either or both handles are of a two-piece construction wherein the cuticle pusher or the nail cleaner or both are removable, inter-changeable, and replaceable with a like-fitting external object preferably with an object suited for nail care.

The foregoing has outlined the more pertinent and important features of the improved manicuring device as set forth in this disclosure in order that the detailed description that follows may be better understood so the present contributions to the art may be more fully appreciated. Additional features of the improved manicuring device will be described hereinafter which form the subject of the claims. It should be appreciated by those skilled in the art that the conception and the disclosed specific embodiment may be readily utilized as a basis for modifying or designing other structures and methods for carrying out the same purposes of the improved manicuring device as set forth in this disclosure. It also should be realized by those skilled in the art that such equivalent constructions and methods do not depart from the spirit and scope of the improved manicuring device as set forth in the appended claims.

### BRIEF DESCRIPTION OF THE DRAWINGS

For a fuller understanding of the nature and objects of the improved manicuring device as set forth in this disclosure, reference should be had to the following detailed description taken in conjunction with the accompanying drawings in which:

FIG. 1 is a detailed front elevation view of a fingernail.

FIG. 2 is a perspective view of the multi-function nipper.

FIG. 3, as taken on line 3-3 of FIG. 2, is a detailed view of the handle of the multi-function nipper.

FIG. 4, as taken on line 4-4 of FIG. 3, is an end view of the handle of the multi-function nipper.

FIG. 5 is one embodiment of a removable end section of a handle illustrating a snap-fit.

FIG. 6 is another embodiment of a removable end section of a handle illustrating a friction-fit.

FIG. 7 is another embodiment of a removable end section of a handle illustrating a threaded-fit.

FIG. 8 is another embodiment of a removable end section of a handle illustrating a bayonet-fit.

### DETAILED DESCRIPTION

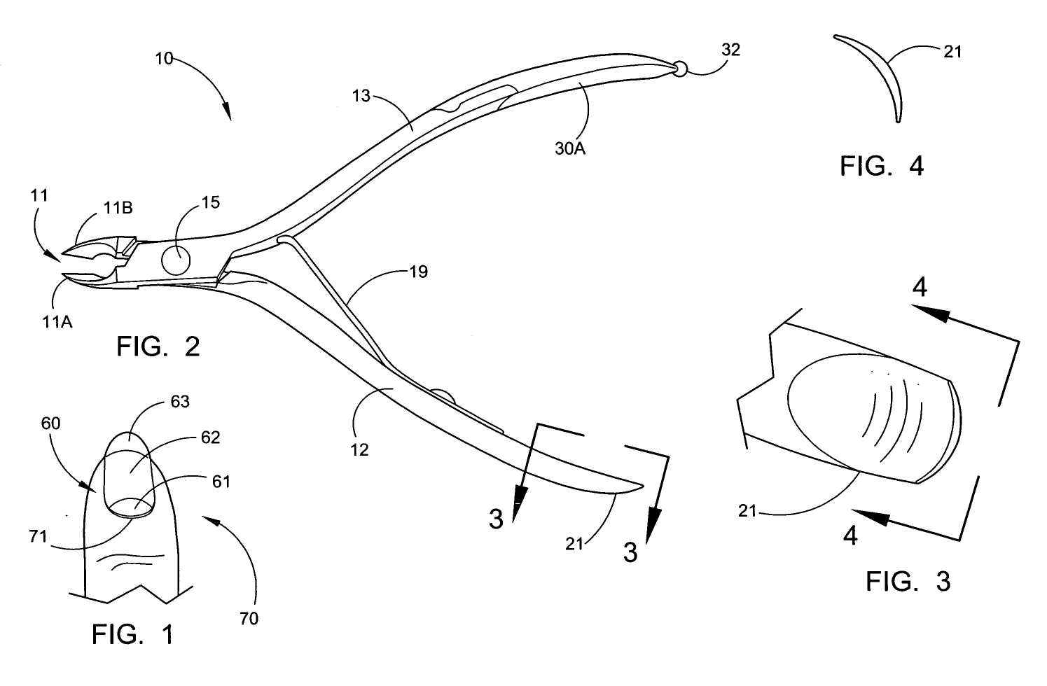

Referring now to the drawings in detail and in particular to FIGS. 1 through 4, reference character 10 of FIG. 2 generally designates an improved manicuring nipper constructed in accordance with a preferred embodiment thereof.

FIG. 1 is illustrative of a human finger 70 having a cuticle 71 and fingernail 60. The fingernail 60 consists of, from the cuticle 71 up, the lunula 61 [moon-like white section], the nail body 62 [pinkish section], and the free edge 63 [the basically white-like in color distal end grown out from the distal end of the finger 70].

A conventional prior-art manicuring nipper is generally not unlike the basic structure of the improved nipper 10 illustrated in FIG. 2 except for the unique distal handle ends of the improved nipper 10. Consequently, FIG. 2 will be used to describe a prior-art nipper. A prior-art nipper has a cutting head 11 with a first blade component 11B and a second blade component 11A and a first handle 12 and a second handle 13 attached to each blade component 11A, 11B. The handles 12, 13 are pivotably connected to one another at a pivot point 15 by a conventional connection member.

A conventional nipper also may have a biasing member 19 between the two handles 12, 13 exerting outward force on the handles 12, 13 to force the blades 11A, 11B of the cutting head 11 open after each cut has been made. A user typically would use the nipper to cut a person's cuticle and, either before of after such cut, would use another implement [a conventional cuticle pusher, not shown] to push the cuticle 71 downward from the lunula 61 to facilitate the initial cut or follow-on cuts or for greater exposure of the lunula 61. The distal end of a typical cuticle pusher is curved to accommodate the curvilinear nature of one's fingernails.

In a typical manicure the user would also clean the underside of a person's free edge 63 using yet another implement, a flat or rounded nail cleaner [similar to that shown in FIGS. 2 and 8 on respective handles 30A, 30D] as desired, to do so. The round-head cleaner may be a ball shape or a rounded flat shape like a pancake. In essence therefore three different implements are required in this process.

The handles 12, 13 of this improved nipper 10 are unique and provide for the ease of use and flexibility of use necessary to eliminate the frustrations associated with using more than one manicuring device when performing a trimming/grooming function on a person's fingernails 60 or cuticles 71 or both.

The present improved nipper 10 is a multi-function nipper 10 having a cuticle pusher 21 integrally connected to a first handle 12 and a free edge cleaner 32 integrally, or removably, connected to the second handle 13. If removably connected, an end section 30A below a middle section of the second handle 13, is removable from the middle section.

FIGS. 3 and 4 illustrate typical curvatures of cuticle pushers. The first handle 12 is relatively straight from the pivot point 15 down and curves at its distal end. Such curvature may be toward the second handle 13 or away from the second handle 13. The second handle has a more curvilinear structure.

As illustrated in FIG. 2, attached to the second handle 13 is a free edge cleaner having a rounded head 32. The head 32 may vary in size from small to medium to large depending on the amount of cleaning required of the underside of the free edge 63 and the size of the free edge 63 involved. The rounded head may be ball-like as illustrated in FIG. 2 or may be round and flat like a pancake.

The rounded head 32, whether ball-like or flat, may also function as an applicator to apply a polish, a water-based paint, or other solution by dabbing onto a finished fingernail 60 to create a flower-like or other design on the fingernail 60. The size of the rounded head 32 would vary depending on the pattern, design, and size desired.

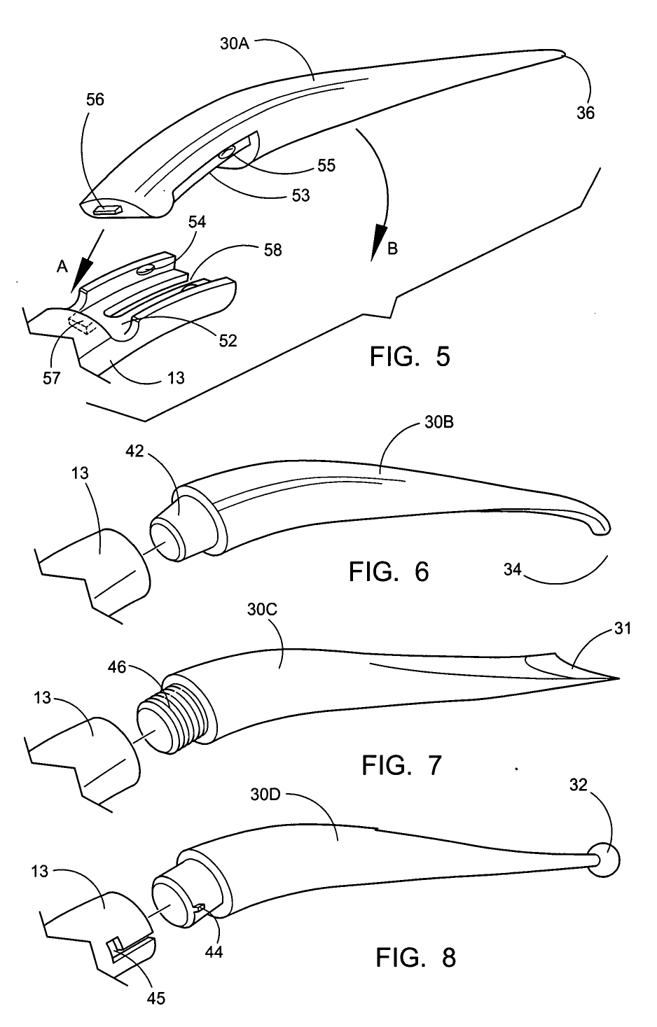

Referring to FIGS. 5 through 6, an alternative free edge cleaner may have a relatively flat and slightly pointed end 36 or may have a relatively flat and curved or slightly hook-like end 34. Any alternative free edge cleaner may be integrally connected to the handle 13 or may be removably connected thereto. As illustrated in FIG. 7, a cuticle pusher 31 may be at the distal end of the removable end section 30C.

In instances where one or both handles 12, 13 have removable end sections, such removable end section 30C may be a conventional corresponding threaded connection structure 46 [FIG. 6], may be a conventional male-to-female friction-fitting 42 [end section 30B of FIG. 5], twist-off bayonet fitting having a nub or detent 44 and corresponding slot 45 [end section 30D of FIG. 8], or a snap-type fitting with corresponding apertures 55 and detents 54 [end section 30A of FIG. 5].

The end section 30A of the snap-type fitting illustrated in FIG. 5 has a registration tab 56 which registers with a corresponding tab slot 57 in the second handle 13. The end section 30A is moved in the direction of Arrow A for tab 56 to register with tab slot 57 after which the end section 30A is moved in the direction of Arrow B. Ledge 53 on the end section 30A mates with recess 52 on the second handle 13 and detents 54 on the second handle 13 in the recess mate with corresponding apertures 55 on the end section 30A.

It must be understand that the location of the detents 54 and respective mating apertures 55 may be inverted; i.e., detents 54 on the end section 30A and apertures 55 in the recess 52 of the second handle 13. A channel 58 in the recess 52 eases the snapping on or off of the end section 30A with respect to the second handle 13.

FIG. 6 illustrates an end section 30B in a friction-fit relationship with the second handle 13. The male extension 42 is angled slightly to fit into the receiving opening [not shown] of the second handle 13 and be held in place thereat. Suitable angling for this purpose is approximately 5° to approximately 9°, with approximately 7° being optimal. It must be understood that the male extension 42 may be on the second handle 13 and the opening on the end section 30B.

FIG. 7 illustrates an end section 30C in a threaded-fit relationship with the second handle 13. The male threading 46 is on the end section 30C and will thread into the receiving threaded opening [not shown] of the second handle 13 and be held in place thereat. It must be understood that the male threading 46 may be on the second handle 13 and the threaded opening on the end section 30C.

FIG. 8 illustrates an end section 30D in a bayonet-fitting relationship with the second handle 13. The end section 30D has a nub 44 thereon which slides into guide slot 45 on the second handle 13 and twists into it at a approximately 90° for a firm fit and hold. It must be understood that the nub 44 may be on the second handle 13 and the guide slot 45 on the end section 30D.

It must also be noted and understood that though the removability of end sections related to the second handle 13, the first handle 12 may be structured similarly.

The present disclosure includes that contained in the present claims as well as that of the foregoing description. Although this improved manicuring device has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the improved manicuring device as set forth in this disclosure. Accordingly, the scope of the improved manicuring device should be determined not by the embodiments illustrated, but by the appended claims and their legal equivalents.

Applicant has attempted to disclose all the embodiments of the improved manicuring device that could be reasonably foreseen. It must be understood, however, that there may be unforeseeable insubstantial modifications to improved manicuring device as set forth in this disclosure that remain as equivalents and thereby falling within the scope of the improved manicuring device.

What is claimed is:

1. An improvement to a manicuring nipper of the type having a cutting head of a first blade and a second blade with a first handle affixed to the first blade and a second handle affixed to the second blade, wherein each said handle is pivotably attached to the other at a pivot connection for opening and closing the cutting head for cutting, wherein the improvement in said nipper comprises a cuticle pusher at a distal end of said first handle.

2. The nipper as claimed in claim 1 wherein said cuticle pusher is curvilinear.

3. The nipper as claimed in claim 1 further comprising a fingernail cleaner at a distal end of said second handle.

4. The nipper as claimed in claim 3 wherein said fingernail cleaner is flat.

5. The nipper as claimed in claim 3 wherein said fingernail cleaner is round.

6. The nipper as claimed in claim 3 wherein said fingernail cleaner is curvilinear.

7. The nipper as claimed in claim 3 wherein said fingernail cleaner is hook-like at its distal end.

8. The nipper as claimed in claim 1 wherein said first handle has a middle section below said pivot connection and an end section below said middle section wherein said end section is removably connected to said middle section and said middle section is adapted to receive different end sections.

9. The nipper as claimed in claim 8 wherein said end section is friction-fitted onto said middle section.

10. The nipper as claimed in claim 8 wherein said end section is threaded into said middle section with each said section having cooperating threading.

11. The nipper as claimed in claim 8 wherein said end section is snap-fitted onto said middle section.

12. The nipper as claimed in claim 8 wherein said end section is bayonet-fitted onto said middle section.

13. The nipper as claimed in claim 1 wherein said second handle has a middle section below said pivot connection and an end section below said middle section wherein said end section is removably connected to said middle section and said middle section is adapted to receive different end sections.

14. The nipper as claimed in claim 13 wherein said end section is friction-fitted onto said middle section.

15. The nipper as claimed in claim 13 wherein said end section is threaded into said middle section with each said section having cooperating threading.

16. The nipper as claimed in claim 13 wherein said end section is snap-fitted onto said middle section.

17. The nipper as claimed in claim 13 wherein said end section is bayonet-fitted onto said middle section.
